(19) United States
(12) Patent Application Publication
(10) Pub. No.: US 2024/0194869 A1
(43) Pub. Date: Jun. 13, 2024

(54) LITHIUM NICKEL MANGANESE COMPOSITE OXIDE, POSITIVE ELECTRODE ACTIVE MATERIAL FOR LITHIUM SECONDARY BATTERY, LITHIUM SECONDARY BATTERY, AND METHOD OF PRODUCING LITHIUM NICKEL MANGANESE COMPOSITE OXIDE

(71) Applicant: HONDA MOTOR CO., LTD., Tokyo (JP)

(72) Inventors: Kazuki Chiba, Wako-shi (JP); Kazumasa Sakatsume, Wako-shi (JP); Akihisa Tanaka, Wako-shi (JP); Takashi Hakari, Wako-shi (JP); Yoshiya Fujiwara, Wako-shi (JP); Yoshiyuki Morita, Wako-shi (JP)

(21) Appl. No.: 18/531,752

(22) Filed: Dec. 7, 2023

(30) Foreign Application Priority Data
Dec. 9, 2022 (JP) 2022-197319

(51) Int. Cl. H01M 4/525; H01M 4/04; H01M 4/505; H01M 10/052

(52) U.S. Cl. CPC H01M 4/525; H01M 4/0471; H01M 4/505; H01M 10/052; H01M 2004/021

(57) ABSTRACT

The present invention relates to a lithium nickel manganese composite oxide which includes secondary particles in which a plurality of primary particles are aggregated with each other, and is represented by General Formula (1): LiₓNi_{y}Mn_{z}O₂ (in Formula (1), x is 0.95≤x≤1.1, y is 0.45≤y≤0.5, z is 0.45≤z≤0.5, and y=z is satisfied), wherein Li contained in a transition metal layer does not form LiMn₆, wherein the lithium nickel manganese composite oxide has a manganese-rich layer from a surface of the secondary particles toward an inside of the secondary particles, wherein a ratio of a number of Mn atoms to a number of Ni atoms (Mn/Ni ratio) in the manganese-rich layer is 1.0 or more and 1.5 or less, and wherein the lithium nickel manganese composite oxide has a space group R-3m, an a-axis lattice constant of 2.87 Å to 2.90 Å, and a c-axis lattice constant of 14.28 Å to 14.32 Å.

### CROSS-REFERENCE TO RELATED APPLICATION

This application is based upon and claims the benefit of priority from Japanese Patent Application No. 2022-197319, filed Dec. 9, 2022, the entire contents of which is incorporated herein by reference.

### FIELD OF THE INVENTION

The present invention relates to a lithium nickel manganese composite oxide, a positive electrode active material for a lithium secondary battery, a lithium secondary battery, and a method of producing a lithium nickel manganese composite oxide.

### DESCRIPTION OF RELATED ART

In recent years, research and development has been conducted on secondary batteries that contribute to energy efficiency in order for more people to secure access to affordable, reliable, sustainable and advanced energy. Most secondary batteries are lithium secondary batteries. In addition, secondary batteries such as lithium secondary batteries are expected to be put into practical use as large batteries for hybrid vehicles and power load leveling systems in the future, and their importance is increasing.

For example, the main components of a lithium secondary battery include electrodes including a positive electrode and a negative electrode each containing a material that can reversibly occlude/release lithium, and a separator containing a non-aqueous electrolytic solution or a solid electrolyte.

Among these components, as an active material for an electrode, a lithium nickel manganese composite oxide with Ni:Mn=1:1 (LiNi_{0.5}Mn_{0.5}O₂) is known (for example, refer to Non-Patent Document 1). It is known that, when such a lithium nickel manganese composite oxide is simply synthesized, the outermost surface is composed of a nickel-rich layer.

### CITATION LIST

### Non-Patent Document

[Non-Patent Document 1] Naoaki Yabuuchi, Yi-Chun Lu, Azzam N. Mansour, Tadashi Kawaguchi, and Yang Shao-Horn, “The Influence of Surface Chemistry on the Rate Capability of LiNi_{0.5}Mn_{0.5}O₂ for Lithium Rechargeable Batteries,” Electrochemical and Solid-State Letters, 13(11)A158-A161(2010).
[Non-Patent Document 2] Naoaki Yabuuchi, Sundeep Kumar, Hayley H. Li, Yong-Tae Kim, and Yang Shao-Horn, “Changes in the Crystal Structure and Electrochemical Properties of LiₓNi_{0.5}Mn_{0.5}O₂ during Electrochemical Cycling to High Voltages,” Journal of The Electrochemical Society, 154(6)A556-A578(2007).
[Non-Patent Document 3] Julien Breger, Ying S. Meng, Yoyo Hinuma, Sundeep Kumar, Kisuk Kang, Yang Shao-Horn, Gerbrand Ceder, and Clare P. Grey, “Effect of High Voltage on the Structure and Electrochemistry of LiNi_{0.5}Mn_{0.5}O₂:A Joint Experimental and Theoretical Study,” Chemistry of Materials, 18(20)4768-4781(2006).

### SUMMARY OF THE INVENTION

In the technique related to secondary batteries, in order to increase the capacity of a lithium secondary battery including a positive electrode containing a positive electrode active material whose main component is a lithium nickel manganese composite oxide (LiNi_{0.5}Mn_{0.5} O₂) with Ni:Mn=1:1, there is a problem in that the secondary battery needs to be kept at a high upper limit voltage (5.0 V) (for example, refer to Non-Patent Documents 2 and 3).

In order to address the above problem, an object of the present invention is to provide a lithium nickel manganese composite oxide in which, when LiMn₆ (for example, refer to Non-Patent Document 3) is not formed by Li contained in a transition metal layer of a lithium nickel manganese composite oxide, and the surface is composed of a manganese-rich layer, the capacity of the lithium secondary battery can be increased even after keeping (aging) at 4.8 V. This accordingly contributes to energy efficiency.

In order to achieve the above object, the present invention provides the following aspects.
[1] A lithium nickel manganese composite oxide which includes secondary particles in which a plurality of primary particles are aggregated with each other, and is represented by General Formula (1): LiₓNi_{y}Mn_{z}O₂ (in Formula (1), x is 0.95≤x≤1.1, y is 0.45≤y≤0.5, z is 0.45≤z≤0.5, and y=z is satisfied),
   wherein Li contained in a transition metal layer does not form LiMn₆,
   wherein the lithium nickel manganese composite oxide has a manganese-rich layer from a surface of the secondary particles toward an inside of the secondary particles,
   wherein a ratio of a number of Mn atoms to a number of Ni atoms (Mn/Ni ratio) in the manganese-rich layer is 1.0 or more and 1.5 or less, and
   wherein the lithium nickel manganese composite oxide has a space group R-3m, an a-axis lattice constant of 2.87 Å to 2.90 Å, and a c-axis lattice constant of 14.28 Å to 14.32 Å.

In the lithium nickel manganese composite oxide of the present invention, is not Li contained in a transition metal layer does not form LiMn₆, the lithium nickel manganese composite oxide has a manganese-rich layer on an surface, has an Mn/Ni ratio of 1.0 or more and 1.5 or less, and has a space group R-3m, an a-axis lattice constant of 2.87 Å to 2.90 Å, and a c-axis lattice constant of 14.28 Å to 14.32 Å. Therefore, when the lithium nickel manganese composite oxide is used as a positive electrode active material for a secondary battery, the capacity of the lithium secondary battery can increase after keeping at 4.8 V.
[2] The lithium nickel manganese composite oxide according to [1],
   wherein, in a spectrum measured by solid-state lithium nuclear magnetic resonance analysis (⁶Li-MAS-NMR) using a magic-angle sample rotation method, there is no peak at 1,495 to 1,505 ppm caused by LiMn₆ formed by Li contained in the transition metal layer.

In a spectrum measured by solid-state lithium nuclear magnetic resonance analysis (⁶Li-MAS-NMR) using a magic-angle sample rotation method, there is no peak at 1,495 to 1,505 ppm caused by LiMn₆ formed by Li contained in the transition metal layer, and thus the surface of the lithium nickel manganese composite oxide of the present invention is a manganese-rich layer.
[3] A positive electrode active material for a lithium secondary battery including the lithium nickel manganese composite oxide according to [1] or [2] as a main component.

Since the positive electrode active material for a lithium secondary battery of the present invention contains the lithium nickel manganese composite oxide of the present invention as a main component, when it is used as a positive electrode active material for a lithium secondary battery, the capacity of the lithium secondary battery can increase.
[4] A lithium secondary battery including a positive electrode, a negative electrode, and an electrolyte,
   wherein the positive electrode contains a positive electrode active material whose main component is the lithium nickel manganese composite oxide according to [1] or [2].

The lithium secondary battery of the present invention can have a high capacity since the positive electrode contains a positive electrode active material whose main component is the lithium nickel manganese composite oxide of the present invention.
[5] A method of producing the lithium nickel manganese composite oxide according to [1] or [2], including:
   a first process in which at least one of lithium and a lithium compound is reacted with NiₐMn_{b} Zₐ (Z is O or OH, a is 0<a<1, b is 0<b<1, a+b=1, and α is a value that keeps NiₐMn_{b}Zₐ electrically neutral) to obtain a powder by heating a mixture containing at least one of lithium and the lithium compound, and NiₐMn_{b}Zₐ at 950° C. or higher and 1,150° C. or lower for 1 minute or longer and 5 hours or shorter;
   a second process of cooling the powder to room temperature;
   a third process in which the powder is immersed in ion-exchanged water at a temperature of 50° C. or higher and 100° C. or lower for 5 minutes or longer and 3 hours or shorter;
   a fourth process of drying the powder after being immersed in ion-exchanged water; and
   a fifth process in which the powder after drying is heated at 800° C. or higher and 950° C. or lower for 1 hour or longer and 24 hours or shorter.

According to the method of producing a lithium nickel manganese composite oxide of the present invention, a lithium nickel manganese composite oxide of the present invention is obtained.

According to the present invention, it is possible to produce a novel lithium nickel manganese composite oxide. When this lithium nickel manganese composite oxide is used as a positive electrode active material for a secondary battery, the capacity of the lithium secondary battery can increase after keeping at 4.8 V.

### BRIEF DESCRIPTION OF THE DRAWINGS

FIG. 1 is a partial cross-sectional view schematically showing an example of a lithium secondary battery according to one embodiment of the present invention.

FIG. 2 is a diagram showing powder X-ray diffraction patterns of lithium nickel manganese composite oxides of Example 1, Comparative Example 1, and Comparative Example 2.

FIG. 3 is a diagram showing ⁶Li-MAS-NMR spectrums of the lithium nickel manganese composite oxides of Example 1 and Comparative Example 1.

FIG. 4 is a diagram showing charging curve of lithium secondary batteries of Example 1 and Comparative Example 1.

FIG. 5 is a diagram showing powder X-ray diffraction patterns of lithium nickel manganese composite oxides of Example 2, Comparative Example 3, and Comparative Example 4.

FIG. 6 is a diagram showing ⁶Li-MAS-NMR spectrums of the lithium nickel manganese composite oxides of Example 2 and Comparative Example 3.

FIG. 7 is a diagram showing charging and discharging curves of lithium secondary batteries of Example 2 and Comparative Example 3.

### DETAILED DESCRIPTION OF THE INVENTION

Hereinafter, embodiments of the present invention will be described in detail.

### [Lithium Nickel Manganese Composite Oxide]

A lithium nickel manganese composite oxide according to one embodiment of the present invention includes secondary particles in which a plurality of primary particles are aggregated with each other and has a manganese-rich layer from the surface of the secondary particles toward the inside of the secondary particles. A center part is located inside the manganese-rich layer. The lithium nickel manganese composite oxide has a multi-layer structure in which the composition inside the secondary particles (center part) is different from the composition of the outer circumferential part (manganese-rich layer). The ratio of the number of Mn atoms to the number of Ni atoms (Mn/Ni ratio) is higher in the composition of the outer circumferential part (manganese-rich layer) than the composition inside the secondary particles (center part).

The lithium nickel manganese composite oxide of the present embodiment is represented by General Formula (1): LiₓNi_{y}Mn_{z}O₂ (in Formula (1), x is 0.95≤x≤1.1, y is 0.45≤y≤0.5, z is 0.45≤z≤0.5, and y=z is satisfied). Formula (1) represents the composition of the entire lithium nickel manganese composite oxide.

In General Formula (1), x indicating a lithium amount is 0.95 or more and less than 1.07. In General Formula (1), y indicating a nickel amount is 0.45 or more and 0.5 or less. In General Formula (1), z indicating a manganese amount is 0.45 or more and 0.5 or less. In addition, in the entire lithium nickel manganese composite oxide, the amount of nickel and manganese is equal (y=z).

The composition of the lithium nickel manganese composite oxide of the present embodiment can be analyzed by inductively coupled plasma (ICP) optical emission spectroscopy.

When the lithium nickel manganese composite oxide of present embodiment is produced, the preparation composition of lithium, nickel, and manganese may be maintained in the obtained lithium nickel manganese composite oxide, or changed in the obtained lithium nickel manganese composite oxide. It is presumed that the composition of lithium, nickel, and manganese in the resulting lithium nickel manganese composite oxide differs from the preparation composition of lithium, nickel, and manganese since lithium evaporates during the production of the lithium nickel manganese composite oxide, or lithium is missing from the crystal structure.

The lithium nickel manganese composite oxide of the present embodiment has a multi-layer structure in which the composition of the center part is different from the composition of the manganese-rich layer of the outer circumferential part, and the Mn amount is adjusted to be higher in the composition of the manganese-rich layer than in the composition of the center part. That is, the lithium nickel manganese composite oxide of present embodiment has a manganese-rich layer on the outermost surface. In the lithium nickel manganese composite oxide of the present embodiment, the ratio of the number of Mn atoms to the number of Ni atoms (Mn/Ni ratio) in the manganese-rich layer is 1.0 or more and 1.5 or less, and preferably 1.0 or more and 1.4 or less. When the Mn/Ni ratio is within the above range, the cycle characteristics of a lithium secondary battery using a lithium nickel manganese composite oxide as a positive electrode active material are improved.

The thickness of the manganese-rich layer is preferably 200 nm or less and more preferably 150 nm or less. The lower limit value of the thickness of the manganese-rich layer may be 1 nm or more or 3 nm or more. When the thickness of the manganese-rich layer is the upper limit value or less, the manganese-rich layer does not inhibit movement of lithium ions, and an effect of improving the capacity of a secondary battery using a lithium nickel manganese composite oxide as a positive electrode active material is obtained.

The composition of the manganese-rich layer can be determined, for example, by qualitative analysis and quantitative analysis using X-ray photoelectron spectroscopy (XPS). According to XPS, the composition of the manganese-rich layer in one particle (the above secondary particles) can be analyzed. That is, the analysis results obtained by XPS do not indicate a local composition within the entire surface of one particle but indicate the composition of the entire surfaces of one particle.

The lithium nickel manganese composite oxide of the present embodiment is a rhombohedral layered compound and has a crystal structure of a space group R-3m.

Since the crystal structure of the lithium nickel manganese composite oxide of the present embodiment has a space group R-3m, an a-axis lattice constant of 2.87 Å to 2.90 Å, and a c-axis lattice constant of 14.28 Å to 14.32 Å, lithium ions are likely to diffuse within primary particles, and the resistance is low.

In order to obtain a lithium nickel manganese composite oxide with a low resistance, the a-axis lattice constant is preferably 2.88 Å to 2.90 Å, and the c-axis lattice constant is preferably 14.29 Å to 14.31 Å.

It can be confirmed that the lithium nickel manganese composite oxide of the present embodiment has an R-3m crystal structure by performing powder X-ray diffraction (XRD) measurement and detecting a peak belonging to R-3m.

In the lithium nickel manganese composite oxide of the present embodiment, in the spectrum measured by solid-state lithium nuclear magnetic resonance analysis (⁶Li-MAS-NMR) using a magic-angle sample rotation method, there is no peak at 1,495 to 1,505 ppm caused by LiMn₆ formed by Li contained in the transition metal layer. The spectrum measured by ⁶Li-MAS-NMR and the spectrum measured by ⁷Li-MAS-NMR have different shapes. In the lithium nickel manganese composite oxide of the present embodiment, in the spectrum measured by ⁶Li-MAS-NMR, there is no peak at 1,495 to 1,505 ppm caused by LiMn₆.

In the lithium nickel manganese composite oxide of the present embodiment, there is no peak at 1,495 to 1,505 ppm caused by LiMn₆ formed by Li contained in the transition metal layer, the lithium nickel manganese composite oxide has a manganese-rich layer on the surface, has an Mn/Ni ratio of 1.0 or more and 1.5 or less, and has a space group R-3m, an a-axis lattice constant of 2.87 Å to 2.90 Å, and a c-axis lattice constant of 14.28 Å to 14.32 Å. Therefore, when the lithium nickel manganese composite oxide is used as a positive electrode active material for a secondary battery, the capacity of the lithium secondary battery can increase after keeping at 4.8 V.

### [Method of Producing Lithium Nickel Manganese Composite Oxide]

A method of producing a lithium nickel manganese composite oxide of the present embodiment is a method of producing the lithium nickel manganese composite oxide according to the above embodiment. The method of producing a lithium nickel manganese composite oxide of the present embodiment includes a first process in which at least one of lithium and a lithium compound is reacted with NiₐMn_{b}Zₐ, (Z is 0 or OH, a is 0<a<1, b is 0<b<1, a+b=1, and α is a value that keeps NiₐMn_{b}Zₐ electrically neutral) to obtain a powder by heating a mixture containing at least one of lithium and the lithium compound, and NiₐMn_{b}Zₐ, at 950° C. or higher and 1,150° C. or lower for 1 minute or longer and 5 hours or shorter, a second process of cooling the powder to room temperature; a third process in which the powder is immersed in ion-exchanged water at a temperature of 50° C. or higher and 100° C. or lower for 5 minutes or longer and 3 hours or shorter, a fourth process of drying the powder after being immersed in ion-exchanged water, and a fifth process in which the powder after drying is heated at 800° C. or higher and 950° C. or lower for 1 hour or longer and 24 hours or shorter.

### “First Process”

In the first process, first, a predetermined amount of at least one of lithium and a lithium compound and a predetermined amount of NiₐMn_{b} Zₐ (Z is 0 or OH, a is 0<a<1, b is 0<b<1, a+b=1, and α is a value that keeps NiₐMn_{b}Zₐ electrically neutral) are dispersed in a solvent such as ethanol and mixed. In the first process, at least one of lithium and a lithium compound and a predetermined amount of NiₐMn_{b}Zₐ may be mixed not only by wet mixing using a solvent but also by dry mixing without using a solvent. As the lithium compound, in addition to LiOH/H₂O, for examples, carbonates such as Li₂CO₃, and acetates such as CH₃COOLi and CH₃COOLi/2H₂O are used. For example, when LiNi_{0.5}Mn_{0.5}O₂ is synthesized as a lithium nickel manganese composite oxide, based on the stoichiometric ratio, LiOH/H₂O is weighed out in an amount of 3 mass % more than Ni_{0.5}Mn_{0.5}(OH)₂. In addition, when Li_{1.1}Ni_{0.45}Mn_{0.45}O₂ is synthesized as a lithium nickel manganese composite oxide, LiOH/H₂O and Ni_{0.5}Mn_{0.5}(OH)₂ are weighed out with a preparation composition of Li:Ni_{0.5}Mn_{0.5}=1.25:0.80.

A mixture containing at least one of lithium and a lithium compound, and NiₐMn_{b}Zₐ is filled into a crucible, and the mixture is heated. As the crucible, a JIS standard platinum crucible or gold crucible is used. The mixture is heated using, for example, a calcination furnace.

The mixture in the crucible is heated at a heating rate of 2.5° C./min to 25° C./min so that the temperature reaches a heat treatment temperature. The heat treatment temperature is 950° C. or higher and 1,150° C. or lower and preferably 1,000° C. or higher and 1,100° C. or lower.

The heat treatment atmosphere is not particularly limited, and examples thereof include air (an air atmosphere) and an oxygen flow. The heat treatment atmosphere is preferably an oxygen flow.

The heat treatment time can be appropriately set depending on the heat treatment temperature, and is 1 minute or longer and 5 hours or shorter, preferably 10 minutes or longer and 3 hours or shorter, and more preferably 10 minutes or longer and 2 hours or shorter. The heat treatment time is a time during which the heat treatment temperature is maintained.

### “Second Process”

In the second process, the temperature of the powder obtained in the first process is cooled to room temperature (25° C.). Examples of the cooling method after the heat treatment in the first process include natural cooling (in-furnace cooling), slow cooling, and the like.

### “Third Process”

The powder, cooled to room temperature, is immersed in ion-exchanged water. The temperature of ion-exchanged water is 50° C. or more and 100° C. or less. The time for immersing the powder in ion-exchanged water (water treatment time) is 5 minutes or longer and 3 hours or shorter. When the temperature of ion-exchanged water is high, the time for immersing the powder in ion-exchanged water becomes shorter. When the temperature of ion-exchanged water is low, the time for immersing the powder in ion-exchanged water becomes longer.

### “Fourth Process”

For example, a hot plate is used to dry the powder after being immersed in ion-exchanged water.

The drying temperature of the powder is preferably 100° C. or more and 130° C. or less.

The drying time of the powder is preferably 10 minutes or more and 30 minutes or less.

### “Fifth Process”

The powder after drying is filled into a crucible, and the powder is heat-treated. For example, a calcination furnace is used for the heat treatment of the powder.

The heat treatment temperature is 800° C. or higher and 950° C. or lower, preferably 850° C. or higher and 900° C. or lower. The heat treatment temperature in the fifth process is preferably lower than the heat treatment temperature in the first process. Furthermore, when the heat treatment temperature is high, the heat treatment time becomes short. When the heat treatment temperature is low, the heat treatment time becomes long.

The heat treatment atmosphere is not particularly limited, and examples thereof include air (an air atmosphere) and an oxygen flow. The heat treatment atmosphere is preferably an oxygen flow.

The heat treatment time is appropriately set depending on the heat treatment temperature, and is 1 hour or longer and 24 hours or shorter, preferably 1 hour or longer and 20 hours or shorter.

According to the method of producing a lithium nickel manganese composite oxide of the present embodiment, the lithium nickel manganese composite oxide of the above embodiment is obtained.

### [Positive Electrode Active Material for Lithium Secondary Battery]

A positive electrode active material for a lithium secondary battery according to one embodiment of the present invention is used for a positive electrode of a lithium secondary battery, and contains the lithium nickel manganese composite oxide of the above embodiment as a main component.

In the positive electrode active material for a lithium secondary battery of the present embodiment, containing the lithium nickel manganese composite oxide as a “main component” means that the amount of the lithium nickel manganese composite oxide is 75 mass % or more, preferably 80 mass % or more, more preferably 90 mass % or more, and still more preferably 99 mass % or more. As long as functions of the present invention are not impaired, the positive electrode active material for a lithium secondary battery may contain components other than the main component.

The positive electrode active material for a lithium secondary battery of the present embodiment may contain only one type of lithium nickel manganese composite oxide of the above embodiment or two or more types of lithium nickel manganese composite oxides of the above embodiment as long as it contains the lithium nickel manganese composite oxide of the above embodiment as a main component.

The positive electrode active material for a lithium secondary battery of the present embodiment can be produced using the lithium nickel manganese composite oxide of the above embodiment.

As described above, when the lithium nickel manganese composite oxide of the above embodiment is used as a positive electrode active material, a lithium secondary battery can have a high capacity.

### [Lithium Secondary Battery]

A lithium secondary battery according to one embodiment of the present invention is a lithium secondary battery including a positive electrode, a negative electrode, an electrolyte, and as necessary, other battery elements, and the positive electrode contains a positive electrode active material whose main component is the lithium nickel manganese composite oxide of the above embodiment.

The lithium secondary battery of the present embodiment can have battery elements of conventionally known lithium secondary batteries without change except that the positive electrode contains a positive electrode active material whose main component is the lithium nickel manganese composite oxide of the above embodiment. The lithium secondary battery of the present embodiment may have any configuration of a coin type, a button type, a cylindrical type, a square type, and a laminate type.

Hereinafter, as an example of the lithium secondary battery of the present embodiment, a lithium secondary battery (coin type lithium secondary battery) using an electrolytic solution will be described. Respective battery elements described below can be similarly applied to an all-solid state lithium secondary battery in which no electrolytic solution is used.

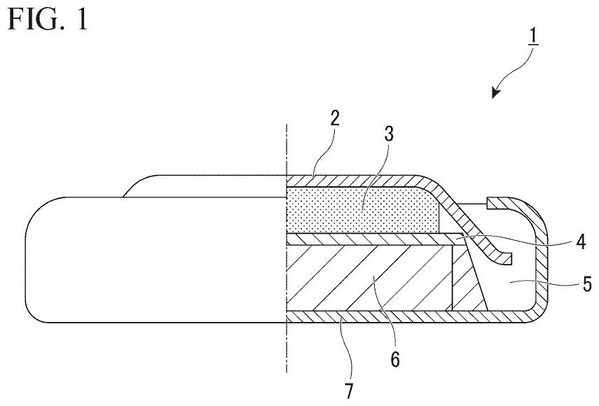

FIG. 1 is a partial cross-sectional view schematically showing an example of a lithium secondary battery of the present embodiment. FIG. 1 shows an example in which the lithium secondary battery of the present embodiment is a coin type lithium secondary battery. A lithium secondary battery 1 shown in FIG. 1 includes a negative electrode terminal 2, a negative electrode 3, a separator 4 impregnated with an electrolytic solution, an insulation packing 5, a positive electrode 6, and a positive electrode can 7.

As shown in FIG. 1, the positive electrode can 7 is placed on the lower side and the negative electrode terminal 2 is placed on the upper side. The positive electrode can 7 and the negative electrode terminal 2 form the external shape of the lithium secondary battery 1.

Between the positive electrode can 7 and the negative electrode terminal 2, the positive electrode 6 and the negative electrode 3 are provided in a layered manner from the bottom.

The separator 4 impregnated with an electrolytic solution is interposed between the positive electrode 6 and the negative electrode 3 to separate them from each other.

The positive electrode can 7 and the negative electrode terminal 2 are electrically insulated by the insulation packing 5.

In the lithium secondary battery of the present embodiment, as necessary, a conductive agent, a binder and the like are added to the positive electrode active material for a lithium secondary battery of the above embodiment to prepare a positive electrode mixture, and this can be compressed onto a current collector to produce a positive electrode. As the current collector, preferably, a stainless steel mesh, an aluminum foil and the like can be used. As the conductive agent, preferably, acetylene black, ketjen black and the like can be used. As the binder, preferably, tetrafluoroethylene, polyvinylidene fluoride and the like can be used.

The formulation of the positive electrode active material, the conductive agent and the binder in the positive electrode mixture is not particularly limited.

The amount of the conductive agent in the positive electrode mixture is preferably 1 mass % to 15 mass % and more preferably 0.1 mass % to 5 mass %. The amount of the binder in the positive electrode mixture is preferably 0.1 mass % to 10 mass %, and more preferably 0.1 mass % to 5 mass %.

For the remainder (other than the conductive agent and the binder) of the positive electrode mixture, it is preferable to add a positive electrode active material, a conductive agent and a binder so that it becomes the positive electrode active material.

In the lithium secondary battery of the present embodiment, as a counter electrode for the positive electrode, any known material that functions as a negative electrode and can occlude/release lithium, for example a metal material such as metal lithium and a lithium alloy, and a carbon material such as graphite and mesocarbon microbeads (MCMB) can be used.

Known battery elements can be used for a separator, a battery container and the like.

As the electrolyte, a known electrolytic solution, solid electrolyte or the like can be used. For example, as an electrolytic solution, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In addition, the all-solid-state lithium secondary battery may have the same structure as a known all-solid-state lithium secondary battery except that the positive electrode active material whose main component is the lithium nickel manganese composite oxide of the above embodiment is used.

In the case of an all-solid-state lithium secondary battery, as the electrolyte, for example, a sulfide-based solid electrolyte, an oxide-based solid electrolyte and the like can be used in addition to polymer-based solid electrolytes such as a polyethylene oxide-based polymer compound and a polymer compound containing at least one type of a polyorganosiloxane chain or polyoxyalkylene chain.

For the positive electrode of the all-solid-state lithium secondary battery, for example, a positive electrode mixture containing a solid electrolyte in addition to the above positive electrode active material, conductive agent and binder may be supported on a positive electrode current collector made of aluminum, nickel, stainless steel or the like.

The lithium secondary battery of the present embodiment can have a high capacity since the positive electrode contains the positive electrode active material whose main component is the lithium nickel manganese composite oxide of the above embodiment.

While the embodiments of the present invention have been described above in detail, the present invention is not limited to the embodiments, and various modifications and changes can be made within the scope of the gist of the present invention described in the scope of the claims.

### EXAMPLES

Hereinafter, examples of the present invention will be described, but the present invention is not limited to the following examples.

### Comparative Example 1

### (Synthesis of Lithium Nickel Manganese Composite Oxide)

LiOH/H₂O (commercially available from Kojundo Chemical Lab. Co., Ltd.) and Ni_{0.5}Mn_{0.5}(OH)₂ were weighed out so that the molar ratio was 1:1, and in consideration of evaporation of Li, based on the stoichiometric ratio, LiOH/H₂O was weighed out in an amount of 3 mass % more than Ni_{0.5}Mn_{0.5}(OH)₂. The total mass of LiOH/H₂O and Ni_{0.5}Mn_{0.5}(OH)₂ was 2.1 g. These were dispersed in ethanol and mixed in a mortar. Then, the mixture of LiOH/H₂O and Ni_{0.5}Mn_{0.5}(OH)₂ was filled into a JIS standard platinum crucible (30 ml). Using a calcination furnace (product name: KDF-75Plus, commercially available from Denken Co., Ltd.), in air, the mixture filled into the platinum crucible was heated at a heating rate of 10° C./min and calcined at 1,050° C. for 30 minutes.

### (Analysis)

The chemical composition of the obtained sample was analyzed by an ICP optical emission spectrometer (product name: Agilent 5110 VDV, commercially available from Agilent Technologies, Inc.). The results are shown in Table 1. As shown in Table 1, it was confirmed that Li:Ni:Mn=1.0:0.50:0.50.

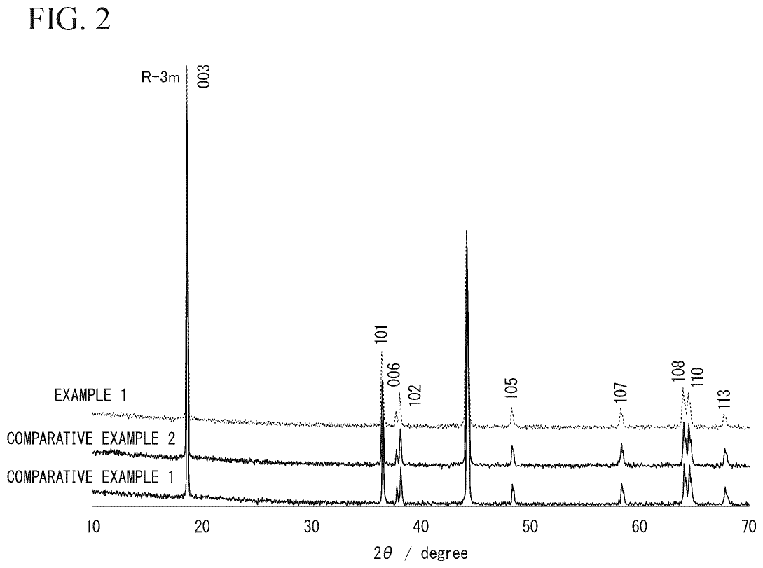

In addition, when the X-ray diffraction pattern of the obtained sample was measured using a powder X-ray diffraction device (product name: SmartLab, commercially available from Rigaku Corporation), and the lattice constants were determined by the least squares method using each index or its interplanar spacing, a=2.88884(4) and c=14.3008(2). The powder X-ray diffraction patterns are shown in FIG. 2. The lattice constants are shown in Table 1.

In addition, the composition of the surface layer of the obtained sample was analyzed by quantitative analysis using an X-ray photoelectron spectroscopy (XPS) analysis device (product name: K-Alpha⁺, commercially available from Thermo Fisher Scientific). The results are shown in Table 1. As shown in Table 1, the Mn/Ni ratio in the surface layer was 1.05.

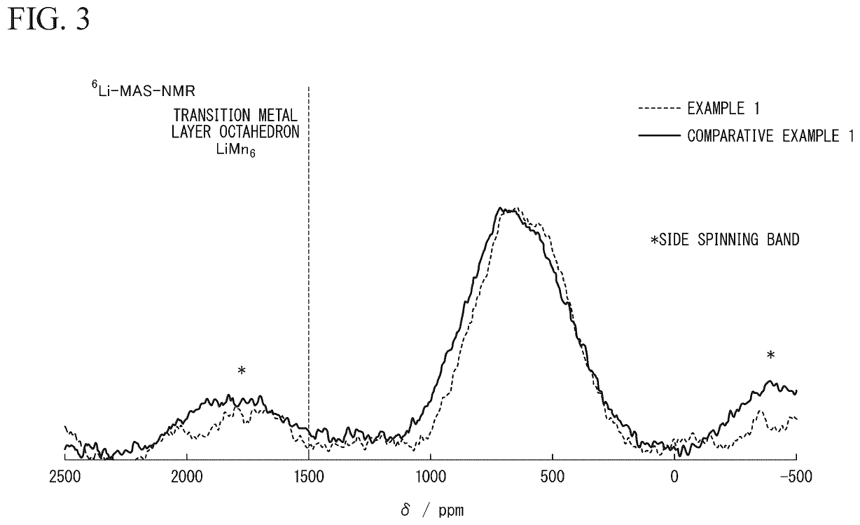

In addition, the obtained sample was analyzed by Li-MAS-NMR (product name: AVANCE300, commercially available from Bruker Corporation). The results are shown in FIG. 3. Based on the results shown in FIG. 3, in the ⁶Li-MAS-NMR spectrum, there was no peak at 1,495 to 1,505 ppm.

### Comparative Example 2

### (Synthesis of Lithium Nickel Manganese Composite Oxide)

1.5 g of LiNi_{0.5}Mn_{0.5}O₂ obtained in Comparative Example 1 was immersed for 5 minutes in 50 mL of ion-exchanged water whose temperature was adjusted to 90° C.

Then, LiNi_{0.5}Mn_{0.5}O₂ was placed on a hot plate whose temperature was adjusted to 120° C. and dried for 15 minutes.

### (Analysis)

The chemical composition of the obtained sample was analyzed in the same manner as in Comparative Example 1. The results are shown in Table 1. As shown in Table 1, it was confirmed that Li:Ni:Mn=0.96:0.50:0.50.

In addition, when the lattice constants of the obtained sample were determined in the same manner as in Comparative Example 1, a=2.88879(3) and c=14.2962(3). The powder X-ray diffraction patterns are shown in FIG. 2. The lattice constants are shown in Table 1.

In addition, the composition of the surface layer of the obtained sample was analyzed in the same manner as in Comparative Example 1. The results are shown in Table 1. As shown in Table 1, the Mn/Ni ratio in the surface layer was 1.22.

### Example 1

### (Synthesis of Lithium Nickel Manganese Composite Oxide)

1.5 g of LiNi_{0.5}Mn_{0.5}O₂ obtained in Comparative Example 2 was filled into a JIS standard platinum crucible. Using a calcination furnace, in air, the mixture filled into the platinum crucible was heated at a heating rate of 10° C./min and calcined at 900° C. for 15 hours.

### (Analysis)

The chemical composition of the obtained sample was analyzed in the same manner as in Comparative Example 1. The results are shown in Table 1. As shown in Table 1, it was confirmed that Li:Ni:Mn=0.96:0.50:0.50.

In addition, when the lattice constants of the obtained sample were determined in the same manner as in Comparative Example 1, a=2.89258(5) and c=14.3149(4). The powder X-ray diffraction patterns are shown in FIG. 2. The lattice constants are shown in Table 1.

In addition, the composition of the surface layer of the obtained sample was analyzed in the same manner as in Comparative Example 1. The results are shown in Table 1. As shown in Table 1, the Mn/Ni ratio in the surface layer was 1.30.

In addition, the obtained sample was analyzed by Li-MAS-NMR. The results are shown in FIG. 3. Based on the results shown in FIG. 3, in the ⁶Li-MAS-NMR spectrum, there was no peak at 1,495 to 1,505 ppm.

### [Production of Lithium Secondary Battery]

LiNi_{0.5}Mn_{0.5}O₂ of Comparative Example 1 or LiNi_{0.5}Mn_{0.5}O₂ of Example 1 as a positive electrode active material, acetylene black as a conductive agent, and polyvinylidene fluoride as a binder were mixed at a weight ratio of 8:1:1, and the obtained mixture was applied to an aluminum foil to produce a positive electrode. The coating area density was 4.5 mg/cm², and the volume density was 2.3 g/cm³. For the positive electrode, lithium metal was used as a counter electrode, and 1.2 mol/L of a solution in which lithium hexafluorophosphate was dissolved in a mixed solvent containing ethylene carbonate (EC), dimethyl carbonate (DMC) and ethyl methyl carbonate (EMC) (a volume ratio of 3:4:3) was used as an electrolytic solution, and thereby a lithium secondary battery (coin type cell) having a structure shown in FIG. 1 was produced. The battery was produced according to a known cell configuration/assembly method.

### [Charging and Discharging Test]

The produced lithium secondary battery was subjected to a charging and discharging test under a temperature condition of 25° C. at a current density of 10 mA/g (0.05 C), and a cutoff potential of 4.8 V to 2.5 V, and charging and discharging characteristics were evaluated. The charging and discharging test started with charging.

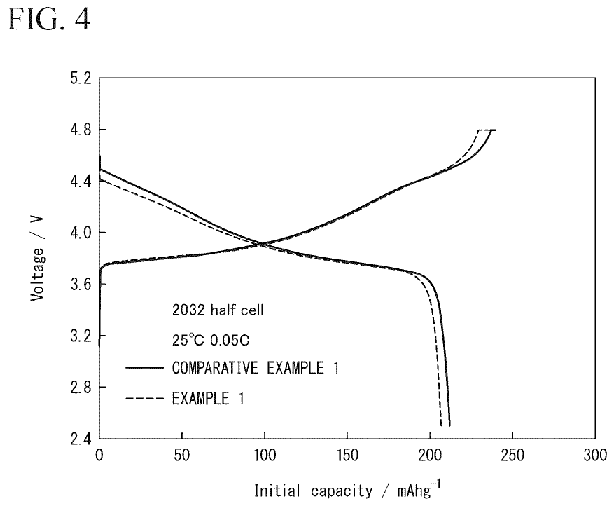

FIG. 4 shows charging and discharging curves associated with charging and discharging in Comparative Example 1 and Example 1. FIG. 4 shows voltage changes during discharging (inserting lithium) in which the cell voltage decreased as the capacity increased, and voltage changes during charging (lithium desorption) in which the cell voltage increased as the capacity increased.

As shown in FIG. 4, it was found that the lithium secondary battery using LiNi_{0.5}Mn_{0.5}O₂ of Example 1 as a positive electrode active material had a higher capacity than the lithium secondary battery using LiNi_{0.5}Mn_{0.5}O₂ of Comparative Example 1 as a positive electrode active material. Based on the results shown in FIG. 4, it was confirmed that the capacity of the lithium secondary battery could be increased by performing appropriate heat treatment.

TABLE 1

| | | | | | Surface |
|---|---|---|---|---|---|
| | | | | | Mn/Ni |
| | Li:Ni:Mn | | | | ratio |
| | (ICP) | a/Å | c/Å | a/c | (XPS) |
| Example 1 | 0.96:0.50:0.50 | 2.89258(5) | 14.3149(4) | 4.949 | 1.30 |
| Compar- | 0.96:0.50:0.50 | 2.88879(3) | 14.2962(3) | 4.949 | 1.22 |
| ative | | | | | |
| Example 2 | | | | | |
| Compar- | 1.0:0.50:0.50 | 2.88884(4) | 14.3008(2) | 4.950 | 1.05 |
| ative | | | | | |
| Example 1 | | | | | |

### Comparative Example 3

### (Synthesis of Lithium Nickel Manganese Composite Oxide)

LiOH/H₂O (commercially available from Kojundo Chemical Lab. Co., Ltd.) and Ni_{0.5}Mn_{0.5}(OH)₂ were weighed out so that the molar ratio of Li:Ni_{0.5}Mn_{0.5} was 1.25:0.80. The total mass of LiOH/H₂O (commercially available from Kojundo Chemical Lab. Co., Ltd.) and Ni_{0.5}Mn_{0.5}(OH)₂ was 2.1 g. These were dispersed in ethanol and mixed in a mortar. Then, the mixture of LiOH/H₂O and Ni_{0.5}Mn_{0.5}(OH)₂ was filled into a JIS standard platinum crucible (30 ml). Using a calcination furnace (product name: KDF-75Plus, commercially available from Denken Co., Ltd.), in air, the mixture filled into the platinum crucible was heated at a heating rate of 10° C./min and calcined at 1,050° C. for 10 minutes.

### (Analysis)

The chemical composition of the obtained sample was analyzed by an ICP optical emission spectrometer (product name: Agilent 5110 VDV, commercially available from Agilent Technologies, Inc.). The results are shown in Table 2. As shown in Table 2, it was confirmed that Li:Ni:Mn=1.1:0.45:0.45.

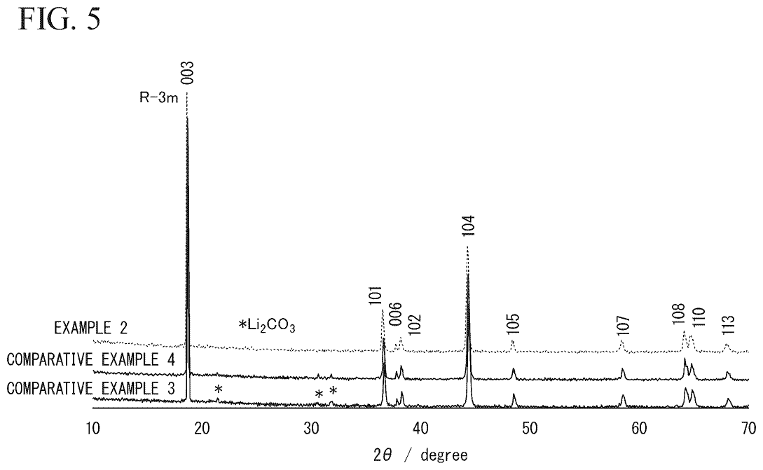

In addition, when the X-ray diffraction pattern of the obtained sample was measured using a powder X-ray diffraction device (product name: SmartLab, commercially available from Rigaku Corporation), and the lattice constants were determined by the least squares method using each index or its interplanar spacing, a=2.86878(12) and c=14.2532(12). The powder X-ray diffraction patterns are shown in FIG. 5. The lattice constants are shown in Table 2.

In addition, the composition of the surface layer of the obtained sample was analyzed by quantitative analysis using an X-ray photoelectron spectroscopy (XPS) analysis device (product name: K-Alpha⁺, commercially available from Thermo Fisher Scientific). The results are shown in Table 2. As shown in Table 2, the Mn/Ni ratio in the surface layer was 0.86.

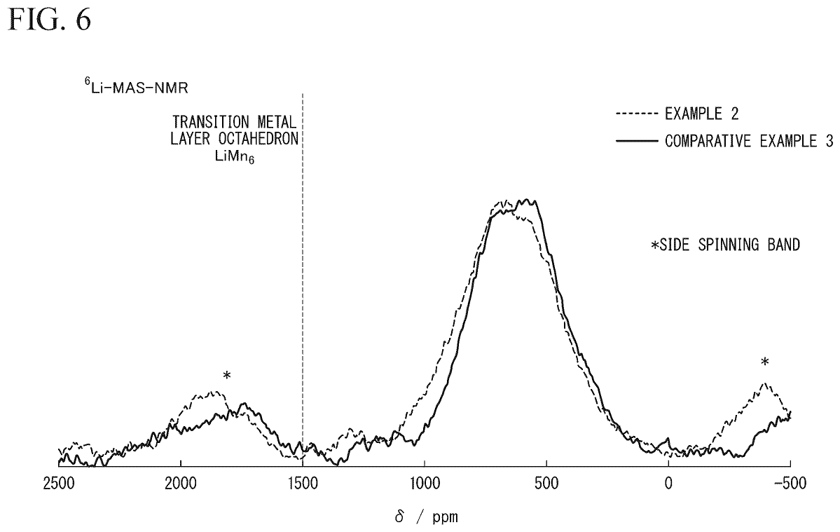

In addition, the obtained sample was analyzed by Li-MAS-NMR (product name: AVANCE300, commercially available from Bruker Corporation). The results are shown in FIG. 6. Based on the results shown in FIG. 6, in the ⁶Li-MAS-NMR spectrum, there was no peak at 1,495 to 1,505 ppm.

### Comparative Example 41

### (Synthesis of Lithium Nickel Manganese Composite Oxide)

1.5 g of lithium nickel manganese composite oxide obtained in Comparative Example 3 was immersed for 5 minutes in 50 mL of ion-exchanged water whose temperature was adjusted to 90° C.

Then, lithium nickel manganese composite oxide was placed on a hot plate whose temperature was adjusted to 120° C. and dried for 15 minutes.

### (Analysis)

The chemical composition of the obtained sample was analyzed in the same manner as in Comparative Example 3. The results are shown in Table 2. As shown in Table 1, it was confirmed that Li:Ni:Mn=1.1:0.45:0.45.

In addition, when the lattice constants of the obtained sample were determined in the same manner as in Comparative Example 3, a=2.87713(11) and c=14.2801(10). The X-ray diffraction patterns are shown in FIG. 5. The lattice constants are shown in Table 2.

In addition, the composition of the surface layer of the obtained sample was analyzed in the same manner as in Comparative Example 3. The results are shown in Table 2. As shown in Table 2, the Mn/Ni ratio in the surface layer was 0.87.

### Example 2

### (Synthesis of Lithium Nickel Manganese Composite Oxide)

1.5 g of lithium nickel manganese composite oxide obtained in Comparative Example 4 was filled into a JIS standard platinum crucible. Using a calcination furnace, in air, the sample filled into the platinum crucible was heated at a heating rate of 10° C./min and calcined at 950° C. for 5 hours.

### (Analysis)

The chemical composition of the obtained sample was analyzed in the same manner as in Comparative Example 3. The results are shown in Table 2. As shown in Table 1, it was confirmed that Li:Ni:Mn=0.94:0.45:0.45.

In addition, when the lattice constants of the obtained sample were determined in the same manner as in Comparative Example 3, a=2.87909(10) and c=14.2908(10). The X-ray diffraction patterns are shown in FIG. 5. The lattice constants are shown in Table 2.

In addition, the composition of the surface layer of the obtained sample was analyzed in the same manner as in Comparative Example 3. The results are shown in Table 2. As shown in Table 2, the Mn/Ni ratio in the surface layer was 1.35.

In addition, the obtained sample was analyzed by Li-MAS-NMR in the same manner as in Comparative Example 3. The results are shown in FIG. 6. Based on the results shown in FIG. 6, in the ⁶Li-MAS-NMR spectrum, there was no peak at 1,495 to 1,505 ppm.

### [Production of Lithium Secondary Battery]

The lithium nickel manganese composite oxide of Comparative Example 3 or the lithium nickel manganese composite oxide of Example 2 as a positive electrode active material, acetylene black as a conductive agent, and polyvinylidene fluoride as a binder were mixed at a weight ratio of 8:1:1, and the obtained mixture was applied to an aluminum foil to produce a positive electrode. The coating area density was 4.5 mg/cm², and the volume density was 2.3 g/cm³. For the positive electrode, lithium metal was used as a counter electrode, and 1.2 mol/L of a solution in which lithium hexafluorophosphate was dissolved in a mixed solvent containing ethylene carbonate (EC), dimethyl carbonate (DMC) and ethyl methyl carbonate (EMC) (a volume ratio of 3:4:3) was used as an electrolytic solution, and thereby a lithium secondary battery (coin type cell) having a structure shown in FIG. 1 was produced. The battery was produced according to a known cell configuration/assembly method.

### [Charging and Discharging Test]

The produced lithium secondary battery was subjected to a charging and discharging test under a temperature condition of 25° C. at a current density of 10 mA/g (0.05 C), and a cutoff potential of 4.8 V to 2.5 V, and charging and discharging characteristics were evaluated. The charging and discharging test started with charging.

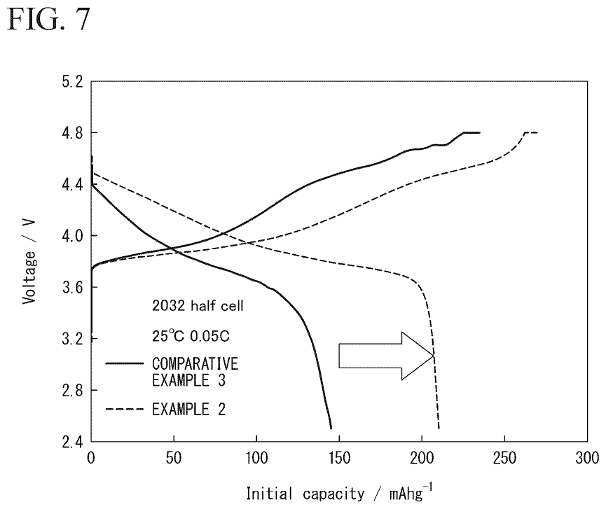

FIG. 7 shows charging and discharging curves associated with charging and discharging in Comparative Example 3 and Example 2. FIG. 7 shows voltage changes during discharging (inserting lithium) in which the cell voltage decreased as the capacity increased, and voltage changes during charging (lithium desorption) in which the cell voltage increased as the capacity increased.

As shown in FIG. 7, it was found that the lithium secondary battery using lithium nickel manganese composite oxide of Example 2 as a positive electrode active material had a higher capacity than the lithium secondary battery using lithium nickel manganese composite oxide of Comparative Example 3 as a positive electrode active material. Based on the results shown in FIG. 7, it was confirmed that the lithium nickel manganese composite oxide of Example 2 could increase the capacity of the lithium secondary battery.

TABLE 2

| | | | | | Surface |
|---|---|---|---|---|---|
| | | | | | Mn/Ni |
| | Li:Ni:Mn | | | | ratio |
| | (ICP) | a/Å | c/Å | a/c | (XPS) |
| Example 3 | 0.94:0.45:0.45 | 2.87909(10) | 14.2908(10) | 4.946 | 1.35 |
| Compar- | 1.1:0.45:0.45 | 2.87713(11) | 14.2801(10) | 4.963 | 0.87 |
| ative | | | | | |
| Example 4 | | | | | |
| Compar- | 1.1:0.45:0.45 | 2.86878(12) | 14.2532(12) | 4.968 | 0.86 |
| ative | | | | | |
| Example 3 | | | | | |

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Lithium secondary battery
2 Negative electrode terminal
3 Negative electrode
4 Separator impregnated with electrolytic solution
5 Insulation packing
6 Positive electrode
7 Positive electrode can

What is claimed is:

1. A lithium nickel manganese composite oxide which includes secondary particles in which a plurality of primary particles are aggregated with each other, and is represented by General Formula (1): LiₓNi_{y}Mn_{z}O₂ (in Formula (1), x is 0.95≤x≤1.1, y is 0.45≤y≤0.5, z is 0.45≤z≤0.5, and y=z is satisfied),
wherein Li contained in a transition metal layer does not form LiMn₆,
wherein the lithium nickel manganese composite oxide has a manganese-rich layer from a surface of the secondary particles toward an inside of the secondary particles,
wherein a ratio of a number of Mn atoms to a number of Ni atoms (Mn/Ni ratio) in the manganese-rich layer is 1.0 or more and 1.5 or less, and
wherein the lithium nickel manganese composite oxide has a space group R-3m, an a-axis lattice constant of 2.87 Å to 2.90 Å, and a c-axis lattice constant of 14.28 Å to 14.32 Å.

2. The lithium nickel manganese composite oxide according to claim 1,
wherein, in a spectrum measured by solid-state lithium nuclear magnetic resonance analysis (⁶Li-MAS-NMR) using a magic-angle sample rotation method, there is no peak at 1,495 to 1,505 ppm caused by LiMn₆ formed by Li contained in the transition metal layer.

3. A positive electrode active material for a lithium secondary battery comprising the lithium nickel manganese composite oxide according to claim 1 as a main component.

4. A lithium secondary battery comprising a positive electrode, a negative electrode, and an electrolyte,
wherein the positive electrode contains a positive electrode active material whose main component is the lithium nickel manganese composite oxide according to claim 1.

5. A method of producing the lithium nickel manganese composite oxide according to claim 1, comprising:
a first process in which at least one of lithium and a lithium compound is reacted with NiₐMn_{b}Zₐ, (Z is O or OH, a is 0<a<1, b is 0<b<1, a+b=1, and α is a value that keeps NiₐMn_{b}Zₐ electrically neutral) to obtain a powder by heating a mixture containing at least one of lithium and the lithium compound, and NiₐMn_{b}Zₐ at 950° C. or higher and 1,150° C. or lower for 1 minute or longer and 5 hours or shorter;
a second process of cooling the powder to room temperature;
a third process in which the powder is immersed in ion-exchanged water at a temperature of 50° C. or higher and 100° C. or lower for 5 minutes or longer and 3 hours or shorter;
a fourth process of drying the powder after being immersed in ion-exchanged water; and
a fifth process in which the powder after drying is heated at 800° C. or higher and 950° C. or lower for 1 hour or longer and 24 hours or shorter.
